(19) United States
(12) Patent Application Publication
(10) Pub. No.: US 2020/0062213 A1
(43) Pub. Date: Feb. 27, 2020

(54) VEHICLE AIRBAG

(71) Applicant: Ford Global Technologies, LLC, Dearborn, MI (US)

(72) Inventors: ZHENYAN GAO, Northville, MI (US); ROBERT WILLIAM MCCOY, Ann Arbor, MI (US); SAEED DAVID BARBAT, Novi, MI (US); HUIPENG CHEN, Canton, MI (US)

(73) Assignee: Ford Global Technologies, LLC, Dearborn, MI (US)

(21) Appl. No.: 16/111,795

(22) Filed: Aug. 24, 2018

(51) Int. Cl. B60R 21/231; B60R 21/215; B60R 21/2338; B60R 21/013

(52) U.S. Cl. CPC B60R 21/23138; B60R 21/215; B60R 21/2338; B60R 2021/0006; B60R 2021/23382; B60R 2021/23107; B60R 21/013

(57) ABSTRACT

An assembly includes a center console elongated along a longitudinal axis and having a first side and a second side spaced from each other along a lateral axis that is perpendicular to the longitudinal axis. The assembly includes an airbag supported by the center console and inflatable to an inflated position extending along the first side to above the center console and along the lateral axis toward the second side.

### BACKGROUND

A vehicle may include one or more airbags deployable during a vehicle impact to control kinematics of occupants inside the vehicle during the impact. The airbag may be a component of an airbag assembly including a housing supporting the airbag, and an inflation device in communication with the airbag for inflating the airbag from an uninflated position to an inflated position.

### BRIEF DESCRIPTION OF THE DRAWINGS

FIG. 1 is a perspective view of a vehicle having a first airbag and a second airbag in uninflated positions.

FIG. 2 is a front view of seats of the vehicle having the first airbag and the second airbag in the uninflated positions.

FIG. 3 is a cut-away front view of the vehicle having the first airbag in an inflated position and the second airbag in the uninflated position.

FIG. 4 is a cut-away top view of the vehicle having the first airbag in the inflated position and the second airbag in the uninflated position.

FIG. 5 is a front cross section view of a portion of the vehicle having the first airbag in the inflated position and the second airbag in the uninflated position.

FIG. 6 is a cut-away front view of the vehicle having the first airbag in the uninflated position and the second airbag in an inflated position.

FIG. 7 is a block diagram of components of the vehicle.

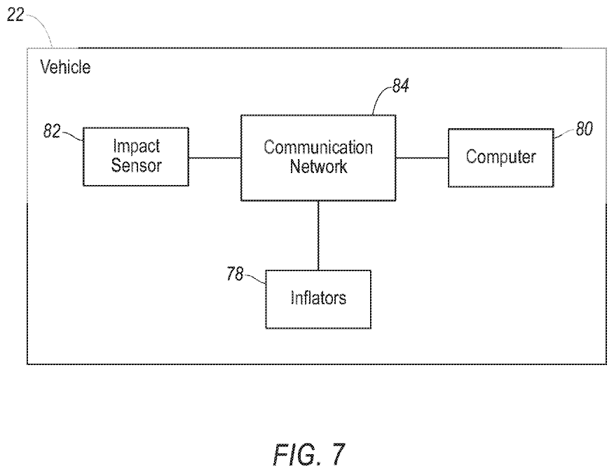

### DETAILED DESCRIPTION

An assembly includes a center console elongated along a longitudinal axis and having a first side and a second side spaced from each other along a lateral axis that is perpendicular to the longitudinal axis. The assembly includes an airbag supported by the center console and inflatable to an inflated position extending along the first side to above the center console and along the lateral axis toward the second side.

The center console may include a top surface and the airbag in the inflated position may abut the top surface.

The center console may include a lid and the airbag in the inflated position may abut the lid.

The first side may include an outer surface and the airbag in the inflated position may abut the outer surface.

The airbag in the inflated position may extend past the second side along the lateral axis.

The center console may include a bin and a trim panel at the first side, the airbag supported between the bin and the trim panel.

The airbag in the inflated position may include a bottom portion extending along the first side and a top portion extending along the lateral axis above the center console, the bottom portion and the top portion being rectangular in cross section along the lateral axis.

The airbag may include an internal tether extending along the lateral axis.

The airbag may include an internal tether extending along a vertical axis that is perpendicular to the longitudinal axis and the lateral axis.

The assembly may include a second airbag supported by the center console and inflatable to an inflated position extending along the second side to above the center console and along the lateral axis toward the first side.

A vehicle includes a center console having a first side and a second side spaced from each other along a cross-vehicle axis. The vehicle includes a seat. The vehicle includes an airbag supported by the center console and inflatable to an inflated position where the airbag extends upward between the first side and the seat and along the cross-vehicle axis toward the second side.

The vehicle may include a second seat spaced from the seat along the cross-vehicle axis, the center console between the seat and the second seat, and the airbag in the inflated position may abut the second seat.

The vehicle may include a second seat spaced from the seat along the cross-vehicle axis and a second airbag supported by the center console and inflatable to an inflated position where the second airbag extends upward between the second side and the second seat and along the cross-vehicle axis toward the first side.

The vehicle may include a processor and a memory storing instructions executable by the processor to inflate the airbag and to refrain from inflating the second airbag based on a detected direction of a vehicle impact.

The detected direction of the vehicle impact may be a side impact opposite the first side or an oblique impact opposite the first side.

The seat may include a seatback, and the airbag in the inflated position may extend to the seatback.

The center console may include a bin, and the airbag may be supported between the bin and the seat.

The airbag may include an internal tether extending along the cross-vehicle axis in the inflated position.

The airbag may include an internal tether extending along a vehicle-vertical axis in the inflated position.

The vehicle may include a processor and a memory storing instructions executable by the processor to inflate the airbag in response to detecting a side impact opposite the first side or an oblique impact opposite the first side.

With reference to the Figures, wherein like numerals indicate like parts throughout the several views, an airbag assembly 20 for a vehicle 22 includes a center console 24 elongated along a longitudinal axis A1. The center console 24 has a first side 26 and a second side 28 spaced from each other along a lateral axis A2 that is perpendicular to the longitudinal axis A1. The airbag assembly 20 includes a first airbag 30 supported by the center console 24 and inflatable to an inflated position extending along the first side 26 to above the center console 24 and along the lateral axis A2 toward the second side 28. The first airbag 30 in the inflated position controls kinematics of an occupant during an impact to the vehicle 22. For example, the first airbag 30 in the inflated position may control kinematics of an occupant seated in a first seat 32 that is adjacent the first side 26 of the center console 24, limiting movement of the occupant toward a second seat 34 that is adjacent the second side 28 of the center console 24, e.g., during a far side impact to the vehicle 22. Similarly, the vehicle 22 may include a second airbag 36 supported by the center console 24 and inflatable to an inflated position extending along the second side 28 to above the center console 24 and along the lateral axis A2 toward the first side 26.

The adjectives “first” and “second” are used throughout this document as identifiers and are not intended to signify importance or order.

The vehicle 22 may be any passenger or commercial automobile such as a car, a truck, a sport utility vehicle, a crossover vehicle, a van, a minivan, a taxi, a bus, etc. The vehicle 22 may define a vehicle-longitudinal axis A3, e.g., extending between a front and a rear of the vehicle 22. The vehicle 22 may define a cross-vehicle axis A4, e.g., extending between a left side and a right side of the vehicle 22. The vehicle 22 may define a vehicle-vertical axis A5, e.g., extending between a top and a bottom of the vehicle 22. The vehicle-longitudinal axis A3, the cross-vehicle axis A4, and the vehicle-vertical axis A5 may be perpendicular to each other. The front, rear, top, bottom, left and right sides, etc., may be relative to an orientation of the occupant of the vehicle 22. The front, rear, top, bottom, left and right sides, etc., may be relative to an orientation of controls for operating the vehicle 22, e.g., an instrument panel. The front, rear, top, bottom, left and right sides, etc., may be relative to a driving direction of the vehicle 22 when wheels of the vehicle 22 are all parallel with each other, etc.

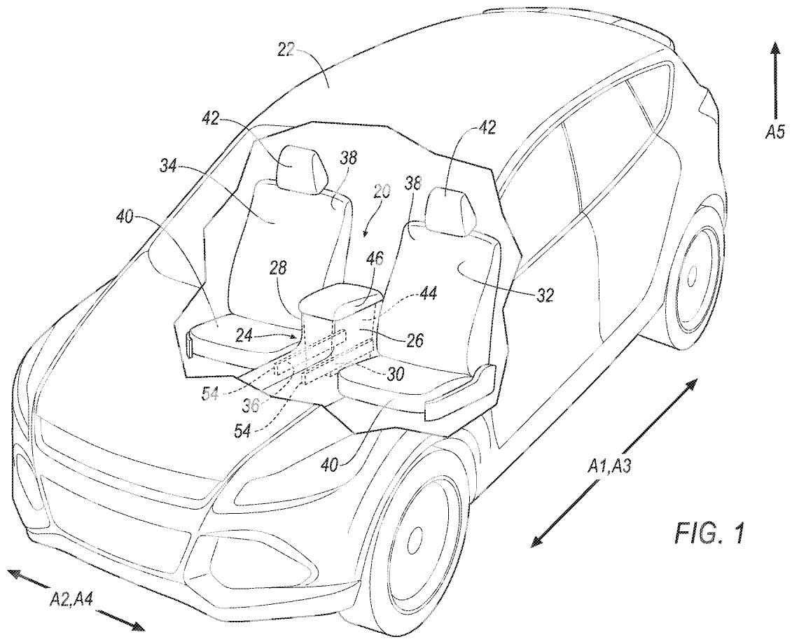

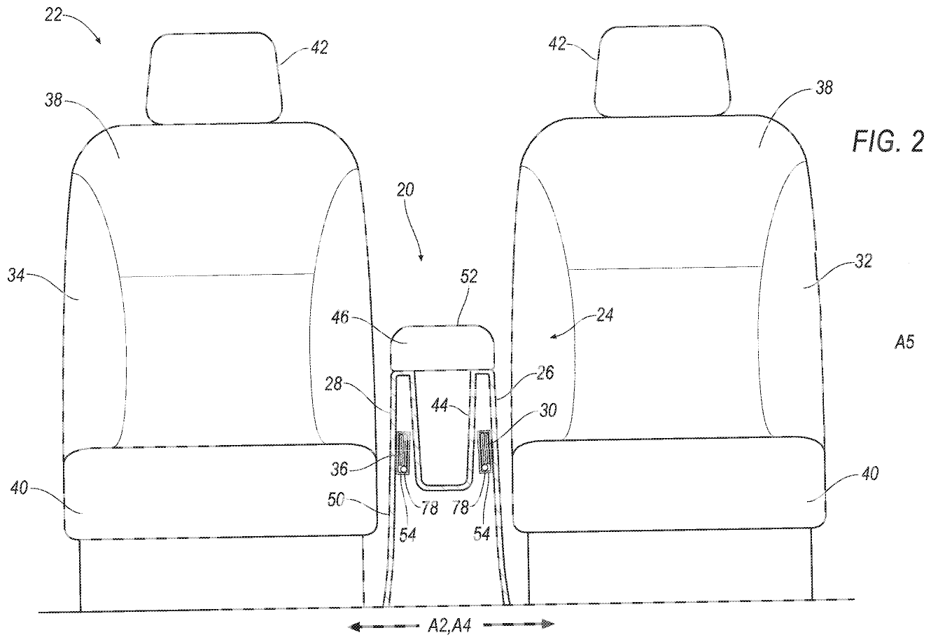

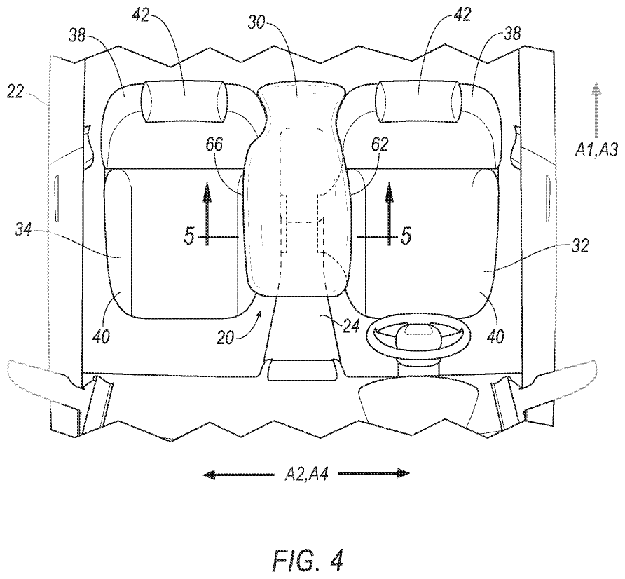

The first seat 32 and the second seat 34 are shown in FIGS. 1-6 as bucket seats, but alternatively the seats 32, 34 may be a bench seat or another type of seats. The second seat 34 may be spaced from the first seat 32 along the cross-vehicle axis A4. For example, the first seat 32 may be a driver side front seat, e.g., at the left side of the vehicle 22. The second seat 34 may be a passenger side front seat, e.g., at the right side of the vehicle 22. The first seat 32 may be at the first side 26 of the center console 24, and the second seat 34 may be at the second side 28 of the center console 24.

The seats 32, 34 may each include a seatback 38, a seat bottom 40, and a head restraint 42. The head restraint 42 may be supported by the seatback 38 and may be stationary or movable relative to the seatback 38. The seatback 38 may be supported by the seat bottom 40 and may be stationary or movable relative to the seat bottom 40. The seatback 38, the seat bottom 40, and/or the head restraint 42 may be adjustable in multiple degrees of freedom. Specifically, the seatback 38, the seat bottom 40, and/or the head restraint 42 may themselves be adjustable, in other words, adjustable components within the seatback 38, the seat bottom 40, and/or the head restraint 42, and/or may be adjustable relative to each other.

The center console 24 is elongated along the longitudinal axis A1. For example, the center console 24 may be elongated along the vehicle-longitudinal axis A3. The center console 24 may be between the first seat 32 and the second seat 34. For example, the center console 24 may extend from the instrument panel toward the rear of the vehicle 22 and between the seats 32, 34.

The center console 24 has the first side 26 and the second side 28. The first side 26 and the second side 28 are spaced from each other along the lateral axis A2. The lateral axis A2 is perpendicular to the longitudinal axis A1. For example, the first side 26 and the second side 28 may be spaced from each other along the cross-vehicle axis A4. The first side 26 and the second side 28 may extend along the vehicle-longitudinal axis A3 and the vehicle-vertical axis A5.

The center console 24 may include a bin 44. The bin 44 may provide storage accessible by the occupant. For example, the bin 44 may be used by the occupant to store a phone, change, etc. The bin 44 may be between the first side 26 and the second side 28 of the center console 24. The bin 44 may include an open top. The center console 24 may include a lid 46. The lid 46 may selectively provide or restrict access to the bin 44. For example, the lid 46 may be above the bin 44, e.g., relative to the vehicle-vertical axis A5, and may move between a closed position covering the open top of the bin 44 and an open position permitting access to the bin 44 via the open top.

The center console 24 may include one or more trim panels 48. The trim panels 48 may be at the first side 26 of the center console 24, the second side 28 of the center console 24 etc. The trim panels 48 may be plastic or any suitable material.

The first side 26 and the second side 28 may each include an outer surface 50. For example, the outer surfaces 50 may be on the trim panels 48 and away from the bin 44. The center console 24 may include a top surface 52. The top surface 52 may face upward relative to the vehicle-vertical axis A5. For example, the top surface 52 may face away from the open top of the bin 44. The outer surfaces 50 and the top surface 52 may be class-A surfaces, i.e., surfaces specifically manufactured to have a high-quality, finished aesthetic appearance free of blemishes

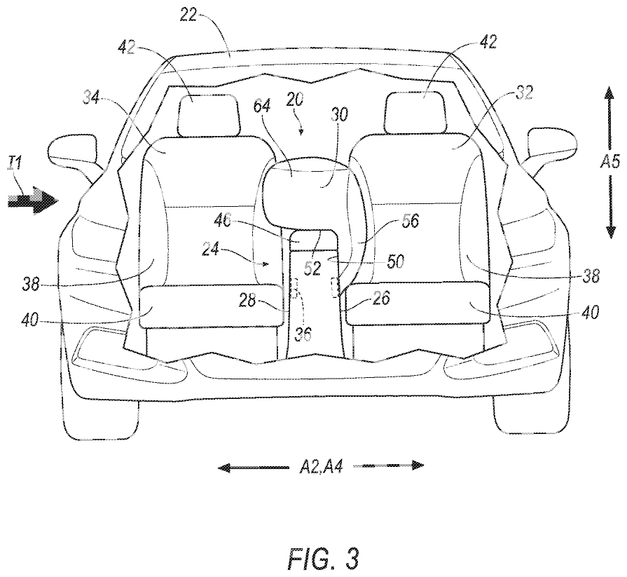

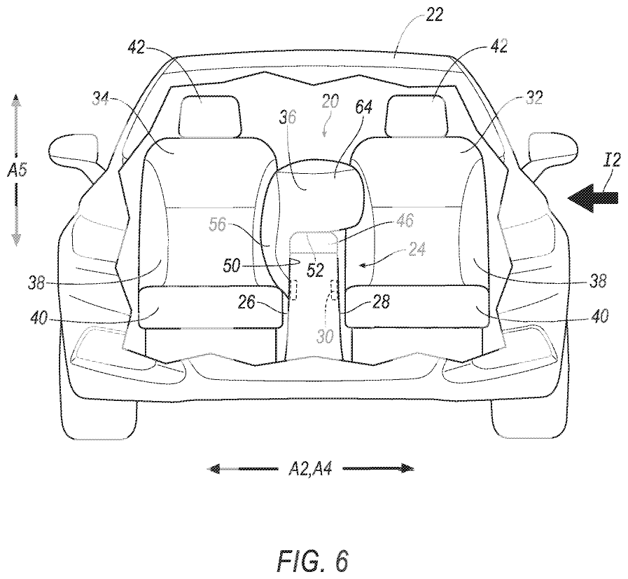

The first airbag 30 is inflatable from an uninflated position, shown in FIGS. 1, 2, and 6, to the inflated position, shown in FIGS. 3-5. The second airbag 36 is inflatable from an uninflated position, shown in FIGS. 1-5, to the inflated position, shown in FIG. 6. The airbags 30, 36 may be formed of a woven polymer or any other material. As one example, the airbags 30, 36 may be formed of woven nylon yarn, for example, nylon 6-6. Other examples include polyether ether ketone (PEEK), polyetherketoneketone (PEKK), polyester, etc. The woven polymer may include a coating, such as silicone, neoprene, urethane, etc. For example, the coating may be polyorgano siloxane.

The airbags 30, 36 are supported by the center console 24. For example, each of the airbags 30, 36 may be supported by a housing 54 (discussed below) that is fixed to the center console 24, e.g., via one or more fasteners, etc. The airbags 30, 36 may be supported between the bin 44 and the seats 32, 34. For example, the first airbag 30 may be supported between the bin 44 and the seat bottom 40 the first seat 32, and the second airbag 36 may be supported between the bin 44 and the seat bottom 40 of the second seat 34. The airbags 30, 36 may be supported between the bin 44 and the trim panels 48. For example, the first airbag 30 may be supported between the bin 44 and the trim panel 48 at the first side 26 of the center console 24, and the second airbag 36 may be supported between the bin 44 and the trim panel 48 at the second side 28 of the center console 24. The airbags 30, 36 in the uninflated positions may be between the bin 44 and the trim panels 48, e.g., along the lateral axis A2 and/or the cross-vehicle axis A4.

The airbags 30, 36 in the inflated positions may each extend along one of the sides 26, 28 to above the center console 24 and along the lateral axis A2 toward the other of the sides 26, 28. In other words, the first airbag 30 may extend along the first side 26 to above the center console 24 and along the lateral axis A2 and/or the cross-vehicle axis A4 toward the second side 28, and the second airbag 36 may extend along the second side 28 to above the center console 24 and along the lateral axis A2 and/or the cross-vehicle axis A4 toward the first side 26.

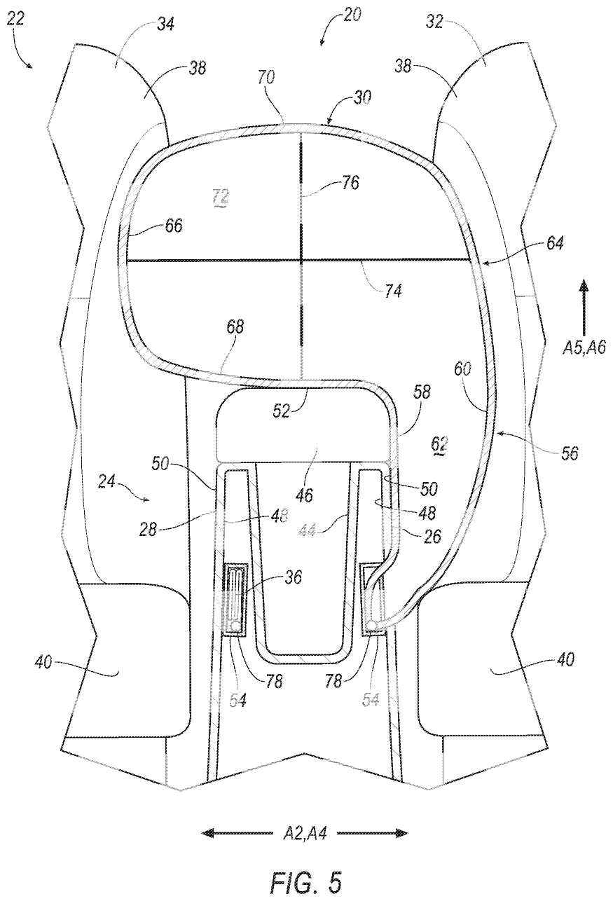

With reference to FIG. 5, each of the airbags 30, 36 in the inflated positions may include a bottom portion 56. The bottom portions 56 may each include an inner panel 58 and a first outer panel 60 spaced from the inner panel 58, e.g., along the lateral axis A2 and/or the cross-vehicle axis A4. The inner panels 58 may be closer to the center console 24 than the first outer panels 60. The inner panels 58 and the first outer panels 60 may extend along the vehicle-longitudinal axis A3 and along the vehicle-vertical axis A5. First chambers 62 may be defined between the inners panels 58 and the first outer panels 60. The bottom portions 56, e.g., the first chambers 62, may be generally rectangular in cross section along the lateral axis A2 and/or the cross-vehicle axis A4. For example, the bottom portions 56 may deviate from a perfect rectangle shape due to the flexible nature of the airbags 30, 36.

The bottom portions 56 may extend along the sides 26, 28 of the center console 24. The bottom portion 56 of the first airbag 30 may extend along the first side 26 of the center console 24. For example, the inner panel 58 of the first airbag 30 may abut the trim panel 48 at the first side 26 of the center console 24 and extend along such trim panel 48, e.g., along the vehicle-longitudinal axis A3 and along the vehicle-vertical axis A5. The bottom portion 56 of the second airbag 36 may extend along the second side 28 of the center console 24. For example, the inner panel 58 of the second airbag 36 may abut the trim panel 48 at the second side 28 of the center console 24 and extend along such trim panel 48, e.g., along the vehicle-longitudinal axis A3 and along the vehicle-vertical axis A5.

Each of the airbags 30, 36 in the inflated positions may include a top portion 64. The top portions 64 may be above the center console 24. For example, the top portions 64 may be above the lid 46 of the center console 24 along the vehicle-vertical axis A5. As another example, the top portions 64 may be above the top surface 52 of center console 24. The top portions 64 may extend along the lateral axis A2 and/or the cross-vehicle axis A4. The top portion 64 of the first airbag 30 may extend from the bottom portion 56 of the first airbag 30 at the first side 26 of the center console 24 toward the second side 28 of the center console 24. The top portion 64 of the second airbag 36 may extend from the bottom portion 56 of the second airbag 36 at the second side 28 of the center console 24 toward the first side 26 of the center console 24.

The top portions 64 may include the first outer panel 60, a second outer panel 66, a bottom panel 68 and a top panel 70. The first outer panels 60 may be spaced from the second outer panels 66 along the cross-vehicle axis A4. The top panels 70 may be spaced from the bottom panels 68 along the vehicle-vertical axis A5. The first outer panels 60 and the second outer panels 66 may extend along the vehicle-longitudinal axis A3 and along the vehicle-vertical axis A5. The first outer panels 60 may extend from the bottom portions 56 to the top panels 70. The second outer panels 66 may extend from the bottom panels 68 to the top panels 70. The top panels 70 and the bottom panels 68 may extend along the vehicle-longitudinal axis A3 and the cross-vehicle axis A4. The top panels 70 may extend from the first outer panels 60 to the second outer panels 66. The bottom panels 68 may extend from the bottom portion 56, e.g., from the inner panel 58, to the second outer panel 66. Second chambers 72 may be defined between the first outer panels 60, the second outer panels 66, the top panels 70, and the bottom panels 68. The second chambers 72 may be in fluid communication with the first chambers 62. In other words, inflation medium may flow from the first chambers 62 to the second chambers 72. The top portions 64, e.g., the second chambers 72, may be generally rectangular in cross section along the lateral axis A2 and/or the cross-vehicle axis A4. For example, the top portions 64 may deviate from a perfect rectangle shape due to the flexible nature of the airbags 30, 36.

The first outer panels 60, the second outer panels 66, the top panels 70, and/or the bottom panels 68 may be fixed to each other, e.g., via stitching, adhesive, friction welding, etc. The first outer panels 60, the second outer panels 66, the top panels 70, and/or the bottom panels 68 may be monolithic, i.e., a single piece of material with no seams, joints, fasteners, or adhesives holding the first outer panels 60, the second outer panels 66, the top panels 70, and/or the bottom panels 68 together.

The airbags 30, 36 in the inflated positions extend upward between the one of the sides 26, 28 of the center console 24 and one of the seats 32, 34. For example, the bottom portion 56 of the first airbag 30 may extend upward along the vehicle-vertical axis A5 from at or below the seat bottom 40 of the first seat 32 toward the lid 46, the top surface 52 of the center console 24, the head restraint 42 of the first seat 32, etc. The bottom portion 56 of the first airbag 30 may be between the trim panel 48 at the first side 26 of the center console 24 and the first seat 32. Similarly, the bottom portion 56 of the second airbag 36 may extend upward along the vehicle-vertical axis A5 from at or below the seat bottom 40 of the second seat 34 toward the lid 46 of the center console 24, the top surface 52 of the center console 24, the head restraint 42 of the second seat 34, etc. The bottom portion 56 of the second airbag 36 may be between the trim panel 48 at the second side 28 of the center console 24 and the second seat 34.

The airbags 30, 36 in the inflated positions may abut the top surface 52 of the center console 24. For example, the bottom panel 68 of the top portion 64 of the first airbag 30 may abut the top surface 52. Similarly, the bottom panel 68 of the top portion 64 of the second airbag 36 may abut the top surface 52.

The airbags 30, 36 in the inflated positions may abut the lid 46 of the center console 24. For example, the bottom panel 68 of the top portion 64 of the first airbag 30 may abut the lid 46. Similarly, the bottom panel 68 of the top portion 64 of the second airbag 36 may abut lid 46.

The airbags 30, 36 in the inflated position may abut the outer surface 50 of one of the sides 26, 28 of the center console 24. For example, inner panel 58 of the first airbag 30 may abut the outer surface 50 at the first side 26 of the center console 24. Similarly, inner panel 58 of the second airbag 36 may abut the outer surface 50 at the second side 28 of the center console 24.

The airbags 30, 36 in the inflated positions may extend from one of the sides 26, 28 of the center console 24 past the other side 26, 28 of the center console 24 along the lateral axis A2 and/or the cross-vehicle axis A4. For example, the top portion 64 of the first airbag 30 may extend along the lateral axis A2 and/or cross-vehicle axis A4 from the trim panel 48 at first side 26 of the center console 24, from the bottom portion 56 of the first airbag 30 at the first side 26, etc., past the trim panel 48 at the second side 28 of the center console 24. In other words, the center console 24 may be between the first outer panel 60 and the second outer panel 66. Similarly, the top portion 64 of the second airbag 36 may extend along the lateral axis A2 and/or cross-vehicle axis A4 from the trim panel 48 at second side 28 of the center console 24, from the bottom portion 56 of the second airbag 36 at the second side 28, etc., past the trim panel 48 at the first side 26 of the center console 24.

The airbags 30, 36 in the inflated position may abut the seat opposite the respective airbag. The first airbag 30 in the inflated position may abut the second seat 34. For example, the second outer panel 66 of the top portion 64 of the first airbag 30 may abut the seatback 38 of the second seat 34. Similarly, the second airbag 36 in the inflated position may abut the first seat 32.

The airbags 30, 36 in the inflated positions may extend to the respective seatback 38. For example, the top portion 64 and/or bottom portion 56 of the first airbag 30 may extend along the vehicle-longitudinal axis A3 from in front of the seatback 38 of the first seat 32, e.g., from a front distal edge of the seat bottom 40 of the first seat 32, to the seatback 38 of the first seat 32. Similarly, the top portion 64 and/or bottom portion 56 of the second airbag 36 may extend along the vehicle-longitudinal axis A3 from in front of the seatback 38 of the second seat 34 to the seatback 38 of the second seat 34.

Each of the airbags 30, 36 may include one or more internal tethers 74, 76. The internal tethers 74, 76 may be in the top portion 64, e.g., in the second chamber 72. One or more of the internal tethers 74 may extend along the lateral axis A2 and/or the cross-vehicle axis A4 in the inflated position. For example, one or more of the internal tethers 74 may connect the one of the first outer panels 60 to one of the second outer panels 66. One or more of the internal tethers 76 may extend along a vertical axis A6 that is perpendicular to the longitudinal axis A1 and the lateral axis A2, and/or along the vehicle-vertical axis A5 in the inflated position. For example, one or more of the internal tethers 76 may connect the one of the top panels 70 to one of the bottom panels 68. The internal tethers 74, 76 may be a same material as the panels 58, 60, 66, 68, 70 of the airbags 30, 34, or any suitable material. The internal tethers 74, 76 may be fixed to one or more of the panels 60, 66, 68, 70. The internal tethers 74, 76 may be monolithic with one or more of the panels 60, 66, 68, 70.

The airbags 30, 36 may be disposed in the housings 54 in the uninflated positions. The housings 54 provide reaction surfaces for the airbags 30, 36 in the inflated positions. The housings 54 may be supported by the center console 24, e.g., between the bin 44 and one of the seats 32, 34, between the bin 44 and one of the trim panels 48, etc. The housings 54 may be formed of any material, e.g., a rigid polymer, a metal, a composite, etc.

An inflator 78 may be connected to each of the airbags 30, 36. Upon receiving a signal from, e.g., a computer 80, the inflator 78 may inflate one of the airbags 30, 36 with an inflatable medium, such as a gas. The inflator 78 may be, for example, a pyrotechnic inflator that uses a chemical reaction to drive inflation medium to the airbag 30, 36. The inflator 78 may be of any suitable type, for example, a cold-gas inflator. The inflator 78 may be disposed in the housing 54.

The vehicle 22 may include an impact sensor 82. The impact sensor 82 is programmed to detect an impact to the vehicle 22. The impact sensor 82 may detect a direction of the impact, e.g., a driver side impact, a passenger side impact, etc. The impact sensor 82 may be of any suitable type, for example, post-contact sensors such as accelerometers, pressure sensors, and contact switches; and pre-impact sensors such as radar, LIDAR, and vision-sensing systems. The vision systems may include one or more cameras, CCD image sensors, CMOS image sensors, etc. The impact sensor 82 may be located at numerous points in or on the vehicle 22.

The vehicle 22 may include a communication network 84. The communication network 84 includes hardware, such as a communication bus, for facilitating communication among components, e.g., the inflator 78, the computer 80, the impact sensor 82, etc. The communication network 84 may facilitate wired or wireless communication among the components in accordance with a number of communication protocols such as controller area network (CAN), Ethernet, WiFi, Local Interconnect Network (LIN), and/or other wired or wireless mechanisms.

The computer 80 may be a microprocessor-based controller implemented via circuits, chips, or other electronic components. For example, the computer 80 may include a processor, memory, etc. The memory of the computer 80 may include memory for storing instructions executable by the processor as well as for electronically storing data and/or databases.

The memory may store instructions executable by the processor to inflate the one of airbags 30, 36 based on a detected direction of an impact to the vehicle 22. The memory may store instructions executable by the processor to refrain from inflating the other of the airbags 30, 36 based on the detected direction of the impact. The computer 80 may detect the direction of the impact based on information from the impact sensor 82, e.g., received via the communication network 84. For example, the computer 80 may detect an impact I1, shown in FIG. 3, to the side of the vehicle 22 opposite the first side 26 of the center console 24, e.g., to the passenger side of the vehicle 22. Such impact I1 may be known as a far side impact relative to the first seat 32. Such impact may be a side impact, e.g., along the cross-vehicle axis A4, or an oblique impact, e.g., transverse to the vehicle-longitudinal axis A3. In response, the computer 80 may transmit an instruction, e.g., via the communication network 84, to one or more of the inflators 78 to inflate the first airbag 30 and may refrain from transmitting an instruction to one or more other inflators 78 to maintain the second airbag 36 in the uninflated position. Similarly, the computer 80 may detect an impact 12, shown in FIG. 6, to the side of the vehicle 22 opposite the second side 28 of the center console 24, e.g., to the driver side of the vehicle 22. In response, the computer 80 may transmit an instruction to one or more inflators 78 to inflate the second airbag 36 and may refrain from transmitting an instruction to one or more other inflators 78 to maintain the first airbag 30 in the uninflated position.

Inflating the airbag 30, 36 opposite the side of the impact controls kinematics of the occupant of the seat 32, 34 opposite the side of the impact. For example, when the impact is to the side of the vehicle 22 adjacent the second seat 34, e.g., the passenger side, the occupant of the first seat 32 may move toward the second seat 34. The inflated first airbag 30 may limit such motion, controlling an amount of head excursion of the occupant toward the second seat 34.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An assembly comprising:
a center console elongated along a longitudinal axis and having a first side and a second side spaced from each other along a lateral axis that is perpendicular to the longitudinal axis; and
an airbag supported by the center console and inflatable to an inflated position extending along the first side to above the center console and along the lateral axis toward the second side.

2. The assembly of claim 1, wherein the center console includes a top surface and the airbag in the inflated position abuts the top surface.

3. The assembly of claim 1, wherein the center console includes a lid and the airbag in the inflated position abuts the lid.

4. The assembly of claim 1, wherein the first side includes an outer surface and the airbag in the inflated position abuts the outer surface.

5. The assembly of claim 1, wherein the airbag in the inflated position extends past the second side along the lateral axis.

6. The assembly of claim 1, wherein the center console includes a bin and a trim panel at the first side, the airbag supported between the bin and the trim panel.

7. The assembly of claim 1, wherein the airbag in the inflated position includes a bottom portion extending along the first side and a top portion extending along the lateral axis above the center console, the bottom portion and the top portion being rectangular in cross section along the lateral axis.

8. The assembly of claim 1, wherein the airbag includes an internal tether extending along the lateral axis.

9. The assembly of claim 1, wherein the airbag includes an internal tether extending along a vertical axis that is perpendicular to the longitudinal axis and the lateral axis.

10. The assembly of claim 1, further comprising a second airbag supported by the center console and inflatable to an inflated position extending along the second side to above the center console and along the lateral axis toward the first side.

11. A vehicle comprising;
a center console having a first side and a second side spaced from each other along a cross-vehicle axis;
a seat; and
an airbag supported by the center console and inflatable to an inflated position where the airbag extends upward between the first side and the seat and along the cross-vehicle axis toward the second side.

12. The vehicle of claim 11, further comprising a second seat spaced from the seat along the cross-vehicle axis, the center console between the seat and the second seat, and wherein the airbag in the inflated position abuts the second seat.

13. The vehicle of claim 11, further comprising a second seat spaced from the seat along the cross-vehicle axis and a second airbag supported by the center console and inflatable to an inflated position where the second airbag extends upward between the second side and the second seat and along the cross-vehicle axis toward the first side.

14. The vehicle of claim 13, further comprising a processor and a memory storing instructions executable by the processor to inflate the airbag and to refrain from inflating the second airbag based on a detected direction of a vehicle impact.

15. The vehicle of claim 14, wherein the detected direction of the vehicle impact is a side impact opposite the first side or an oblique impact opposite the first side.

16. The vehicle of claim 11, wherein the seat includes a seatback, and the airbag in the inflated position extends to the seatback.

17. The vehicle of claim 11, wherein the center console includes a bin, and the airbag is supported between the bin and the seat.

18. The vehicle of claim 11, wherein the airbag includes an internal tether extending along the cross-vehicle axis in the inflated position.

19. The vehicle of claim 11, wherein the airbag includes an internal tether extending along a vehicle-vertical axis in the inflated position.

20. The vehicle of claim 11, further comprising a processor and a memory storing instructions executable by the processor to inflate the airbag in response to detecting a side impact opposite the first side or an oblique impact opposite the first side.
